(19) United States
(12) Patent Application Publication
(10) Pub. No.: US 2010/0048791 A1
(43) Pub. Date: Feb. 25, 2010

(54) SPHERICAL CALCIUM CARBONATE PARTICLES

(75) Inventors: Marijan Vucak, Altendiez (DE); Katarzyna Gorna, Pabianice (PL); Gerhard Wegner, Mainz (DE)

Correspondence Address: FOLEY AND LARDNER LLP;SUITE 500, 3000 K STREET NW, WASHINGTON, DC, 20007, US

(73) Assignee: Schaefer Kalk GmbH & Co. KG

(21) Appl. No.: 12/594,929

(22) PCT Filed: Mar. 22, 2008
(86) PCT No.: PCT/EP08/02321

§ 371 Date: Oct. 6, 2009

(30) Foreign Application Priority Data
Apr. 7, 2007 (DE) 10 2007 016 580.5
Apr. 21, 2007 (DE) 10 2007 018 975.5

(51) Int. Cl. C08K 3/26; B32B 5/16

(52) U.S. Cl. 524/425; 428/402

(57) ABSTRACT

Disclosed are spherical calcium carbonate particles that have an average diameter ranging from 0.05 μm to 2.0 μm and a maximum water content of 5.0 percent by weight relative to the total weight thereof. Said calcium carbonate particles are preferably obtained by reacting calcium chloride with dialkyl carbonate in the presence of an alkali metal hydroxide in aqueous solution. The components are advantageously used at the following concentrations: a) CaCl₂: >10 mmol/l to 50 mmol/l; b) dialkyl carbonate: >10 mmol/l to 50 mmol/l; c) alkali metal hydroxide: 20 mmol/l to 100 mmol/l. The disclosed particles are particularly suitable as an additive or modifying agent in paper, paints, plastics, inks, adhesives, and pharmaceuticals.

The invention relates to spherical calcium carbonate particles, a method for their production and their use.

Calcium carbonate, CaCO₃, is a calcium salt of carbonic acid, which is nowadays used in many areas of everyday life. Thus, it is used in particular as an additive or modification agent in paper, dyes, plastics, inks, adhesives and pharmaceuticals. In plastics, calcium carbonate is used primarily as a filler in order to replace the comparatively expensive polymer.

Calcium carbonate appears in different phases in nature. In principle, a distinction is made between the hydrous and the anhydrous phases. Calcite, vaterite and aragonite are structures without the incorporation of water and exhibit the same stoichiometry (polymorphism). Furthermore, there are two crystalline hydrate phases of calcium carbonate: monohydrate and a hexahydrate (ikaite).

Apart from the crystalline forms, an amorphous calcium carbonate (ACC) is also known. ACC is a metastable phase which occurs with a variable water content and in which the atoms do not form ordered structures, but an irregular pattern and therefore have only a short-range order, but not a long-range order. ACC is unstable and transforms into calcite at temperatures above 300° C. This process is accelerated by the presence of water and the crystallisation already takes place at fairly low temperatures.

ACC can be produced on the basis of many different starting materials under many different reaction conditions, e.g. from a calcium chloride solution, which is reacted with sodium hydrogen carbonate in the presence of magnesium ions, with ammonium carbonate or with sodium carbonate, or by hydrolysis of dimethyl carbonate in a calcium chloride solution.

The last route is discussed in particular in the dissertation by M. Faatz “Controlled Precipitation of Amorphous Calcium Carbonate through Homogeneous Carbonate Liberation” Johannes Gutenberg University Mainz 2005, wherein two synthesis variants are examined in greater detail:

On the one hand, 0.001 mol calcium chloride is reacted in 100 ml of aqueous solution with 0.001 mol dimethyl carbonate in the presence of 0.002 mol sodium hydroxide. Alternatively, 0.001 mol calcium chloride is caused to react in 100 ml of aqueous solution with 0.005 mol dimethyl carbonate in the presence of 0.010 mol sodium hydroxide. The deposits obtained are in each case separated and dried, more precise information concerning the drying not being given. Both routes lead to more or less spherical amorphous calcium carbonate particles, which exhibit a residual water content of 0.4 mol to 0.6 mol incorporated water, related to 1 mol calcium carbonate, or 7 wt.-% to 10 wt.-% water, related to the total weight.

Within the scope of this work, the suitability of ACC particles as a filler in ultra-high molecular polyethylene (UHMW-PE) was investigated, the particles being dispersed in situ in the growing polymer chains in order to avoid chain cleavages. The filled polymers obtained in this way possess a melting peak in the range from 137° C. to 139° C., which is less than that of pure UHMW-PE (146° C.).

Against this background, the problem underlying the present invention was to indicate possible ways of preparing calcium carbonate particles with improved properties. In particular, the calcium carbonate particles were to be suitable as a filler for polymers, wherein the mechanical properties of the polymers in particular were, as far as possible, not to be adversely affected by the addition of the filler, but rather were to be improved further as far as possible. At the same time, the fillers were to be capable of being produced in as straightforward a manner as possible, as far as possible on a commercial scale and cost-effectively.

These and other problems not specifically stated, which can be derived directly from the above interrelationships, are solved by the preparation of spherical calcium carbonate particles with all the features of present claim 1. The sub-claims related back to claim 1 describe particularly expedient variants of the spherical calcium carbonate particles. The remaining claims relate to particularly advantageous methods of production for the spherical calcium carbonate particles according to the invention and provide protection for particularly expedient applications of the spherical calcium carbonate particles according to the invention.

By making available spherical calcium carbonate particles with a mean particle diameter in the range from 0.05 μm to 2.0 μm and a water content of at most 5.0 wt.-%, related to their total weight, it is possible in a way not readily foreseeable to make available spherical calcium carbonate particles with an improved property profile and increased long-term stability, which are suitable especially as a filler for polymers, since they can be dispersed extremely homogeneously in the polymer in an extremely straightforward manner. The resulting polymer compounds are characterised by a markedly improved property range and in particular exhibit much improved mechanical properties, such as higher tensile strength, a higher tensile modulus and a greater elongation at tear, as well as a much smoother surface.

Moreover, numerous other advantages also arise through the solution according to the invention:
The spherical calcium carbonate particles according to the invention can be produced on an industrial scale and cost-effectively in a comparatively straightforward manner.
As a result of the rapid and at the same time extremely sparing methods of production of the present invention, it is surprisingly possible to make available spherical calcium carbonate particles with a water content of less than 5.0 wt.-%. This was not to be expected, especially since amorphous calcium carbonate in itself is very unstable and normally transforms into calcite at high temperatures, the transformation being further accelerated by the presence of water.
The calcium carbonate particles according to the invention are isotropic and possess a very regular and spherical shape as well as a comparatively narrow particle size distribution. The formation of larger aggregates is not observed, but on the contrary the particles according to the invention are predominantly present as individual units. This results in numerous advantages in applications, such as a more uniform dispersibility, better processability and improved mechanics and surface properties of polymers filled with calcium carbonate particles according to the invention.
The calcium carbonate particles of the present invention are comparatively dimensionally stable and stable in terms of properties and are therefore eminently well suited for thermoplastic incorporation into plastics, e.g. by extrusion. In contrast with this, thermoplastic processing of the amorphous calcium carbonate from Faatz is virtually impossible on account of the large quantity of structural water and the resultant instability of the particles.

The present invention relates to spherical calcium carbonate particles. In contrast with other known forms of the prior art, the calcium carbonate particles are not therefore constituted, for example, by needles, rhombohedrons or somatoids (precipitated calcium carbonate; PCC) or by regularly formed particles (ground calcium carbonate; GCC), but rather by spherical particles which are preferably present predominantly as individual units. Fairly small deviations from the perfect sphere are however accepted, as long as the properties of the particles, especially their dispersibility, are not fundamentally changed. Thus, the surface of the particles can have occasional faults or additional deposits.

The mean diameter of the calcium carbonate particles is 0.05 μm to 2.0 μm. The mean particle diameter is preferably less than 1.75 μm, particularly preferably less than 1.5 μm, in particular less than 1.2 μm. Furthermore, the mean particle diameter is advantageously greater than 0.1 μm, preferably greater than 0.2 μm, in particular greater than 0.3 μm. It is expediently ascertained by evaluation of REM photographs, only particles with a size of at least 0.01 μm preferably being taken into account and a numerical mean being taken over preferably at least 20, particularly preferably at least 40 particles.

The size distribution of the particles is comparatively narrow and preferably such that at least 90.0 wt.-% of all the calcium carbonate particles have a particle diameter in the range from mean particle diameter −30% to mean particle diameter +30%.

The shape factor of the particles, in the present case defined as the quotient of the minimum particle diameter and the maximum particle diameter, is expediently greater than 0.90, particularly preferably greater than 0.95, for at least 90%, advantageously for at least 95% of all particles. In this connection, only particles with a particle size in the range from 0.1 μm to 2.0 μm are preferably taken into account.

The calcium carbonate particles according to the invention are also characterised by a comparatively low water content. Related to their total weight, they have a water content (residual moisture at 105° C.) of at most 5.0 wt.-%, preferably of at most 2.5 wt.-%, preferably of at most 1.0 wt.-%, particularly preferably of at most 0.75 wt.-%, even more preferably of at most 0.5 wt.-%, in particular of at most 0.4 wt.-%.

The specific surface area of the calcium carbonate particles preferably lies in the range from 2 m²/g to 20 m²/g, particularly preferably in the range from 4 m²/g to 12 m²/g.

Within the scope of a first particularly preferred embodiment of the present invention, the calcium carbonate particles are at least partially amorphous. The term “amorphous” denotes in this connection those calcium carbonate modifications in which the atoms form at least in part no ordered structures, but rather an irregular pattern and therefore have only a short-range order, but not a long-range order. These need to be distinguished from crystalline modifications of calcium carbonate, such as for example calcite, vaterite and aragonite, wherein the atoms have both a short-range order and a long-range order. In the present case, the presence of crystalline components is however not categorically excluded. Preferably, the proportion of crystalline calcium carbonate is however less than 90 wt.-%, preferably less than 75 a,t.-%, advantageously less than 50 wt.-%, particularly preferably less than 30 wt.-%, very particularly preferably less than 15 wt.-%, in particular less than 7 wt.-%.

Within the scope of a further particularly preferred embodiment of the present invention, the proportion of crystalline calcium carbonate is comparatively high and greater than 10 wt.-%, preferably greater than 25 wt.-%, advantageously greater than 50 wt.-%, particularly preferably greater than 70 wt.-%, very particularly preferably greater than 80 wt.-%, in particular greater than 90 vet.-%.

To ascertain the amorphous and the crystalline proportions, x-ray diffraction with an internal standard, preferably aluminium oxide, in combination with a Rietveld refinement, has proved to be particularly well tried and tested.

The production of the spherical calcium carbonate particles can take place in a manner known per se, for example by hydrolysis of dialkyl carbonate, preferably dimethyl carbonate, in a calcium carbonate solution. The reaction is expediently carried out in the presence of an alkali metal hydroxide, particularly preferably sodium hydroxide. The components are advantageously used in the following concentrations:
a) CaCl₂: >10 mmol/l to 50 mmol/l, preferably 15 mmol/l to 45 mmol/l, in particular 17 mmol/l to 35 mmol/l;
b) dialkyl carbonate: >10 mmol/l to 50 mmol/l, preferably 15 mmol/l to 45 mmol/l, in particular 17 mmol/l to 35 mmol/l;
c) alkali metal hydroxide: 20 mmol/l to 100 mmol/l, preferably 20 mmol/l to 50 mmol/l, particularly preferably 25 mmol/l to 45 mmol/l, in particular 28 mmol/l to 35 mmol/l;

Furthermore, the molar ratio of calcium chloride to alkali metal hydroxide in the reaction mixture is preferably greater than 0.5:1 and particularly preferably in the range from >0.5:1 to 1:1, in particular in the range from 0.6:1 to 0.9:1.

The molar ratio of calcium chloride to dialkyl carbonate in the reaction mixture is advantageously in the range from 0.9:1.5 to 1.1:1, particularly preferably in the range from 0.95:1 to 1:0.95. Within the scope of a very particularly expedient variant of the present invention, the dialkyl carbonate and the calcium chloride used are equimolar.

The reaction is preferably carried out at a temperature in the range from 15° C. to 30° C.

The specific size of the calcium carbonate particles can be controlled in a manner known per se by supersaturation.

The calcium carbonate particles are precipitated under the aforementioned conditions from the reaction mixture and can be separated in a manner known per se, e.g. by centrifugation, and if need be cleaned by washing with acetone and dried in a vacuum drying chamber.

For the purposes of the present invention, the calcium carbonate particles thus obtained are dried in a manner such that they exhibit the desired residual water content. For this purpose, the drying has been particularly well tried and tested at a temperature in the range from 150° C. to 220° C., preferably in the range from 160° C. to 210° C., particularly preferably in the range from 170° C. to 210° C., in particular in the range from 180° C. to 200° C. The drying preferably takes place in a circulating air drying chamber. The calcium carbonate particles are expediently dried for at least 3 h, particularly preferably at least 6 h, in particular at least 20 h.

The calcium carbonate particles according to the invention are in principle suitable for all applications prescribed for calcium carbonate. These include, in particular, use as an additive or modification agent in paper, dyes, plastics, inks, adhesives and pharmaceuticals, in particular as a filler of preferably organic polymers.

Particularly expedient polymer compounds contain, in each case related to their total volume, 99.9 vol.-% to 50.0 vol.-%, particularly preferably 95.0 vol.-% to 50.0 vol.-% of at least one polymer and 0.1 vol.-% to 50.0 vol.-%, particularly preferably 5.0 vol.-% to 50 vol.-% of spherical calcium carbonate particles. Thermoplastically processable polymers, polymers thermoplastically processable preferably at temperatures in the range from 100° C. to 250° C., in particular polyethylene, such as LLDPE, HDPE, polypropylene (PP), polystyrene (PS) and polylactic acid (PLA), are particularly preferred in this connection.

The incorporation of the filler into the polymer can take place in a manner known per se, e.g. by thermoplastic processing, extrusion methods having been particularly well tried and tested within the scope of the present invention.

### ILLUSTRATIONS

In the appended figures:

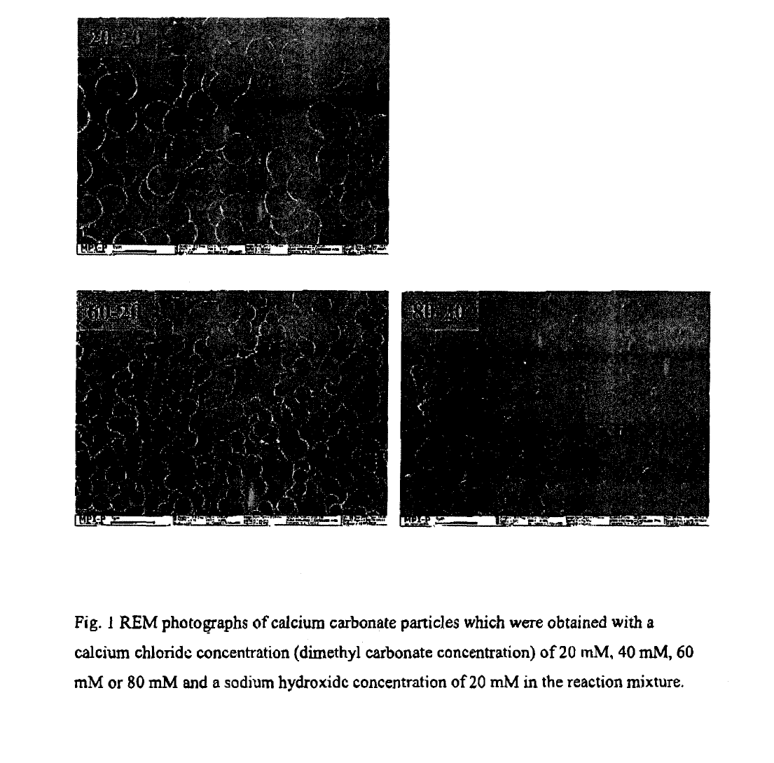

FIG. 1 shows REM photographs of calcium carbonate particles as a function of the calcium chloride concentration in the reaction mixture

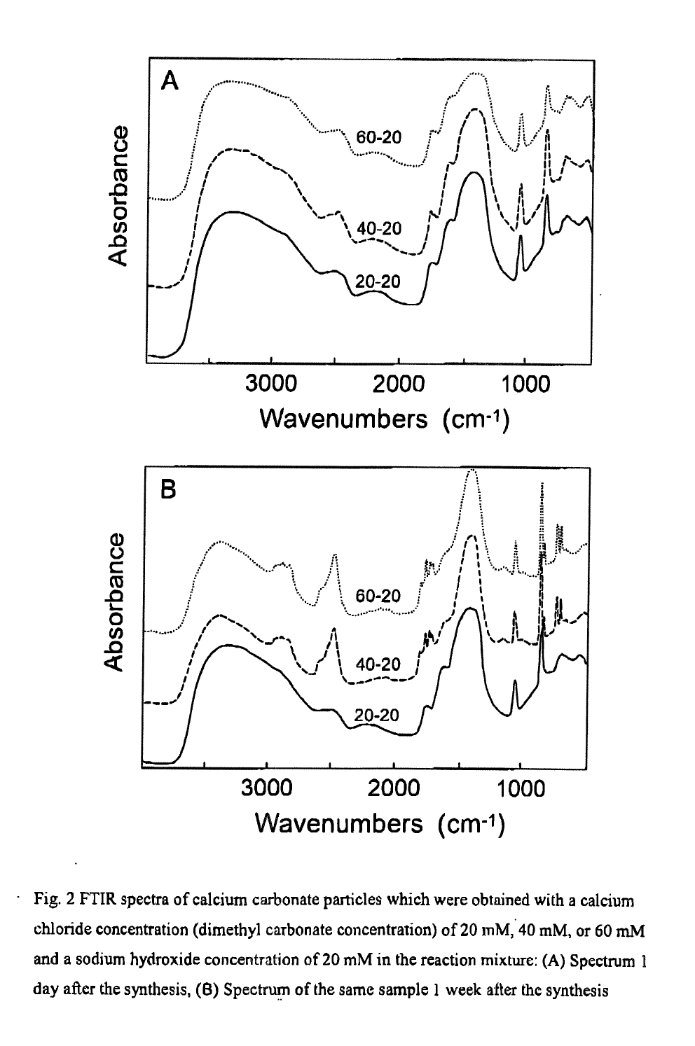

FIG. 2 shows FTIR spectra of calcium carbonate particles as a function of the calcium chloride concentration in the reaction mixture

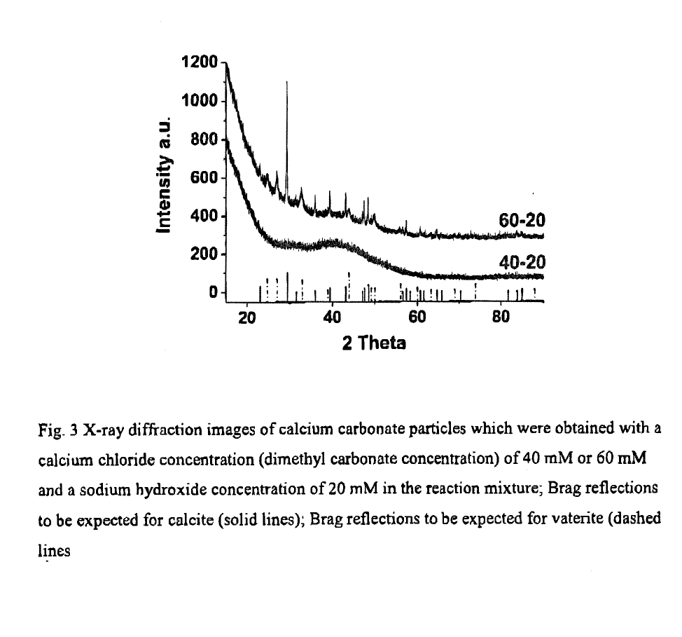

FIG. 3 shows x-ray diffraction images of calcium carbonate particles as a function of the calcium chloride concentration in the reaction mixture

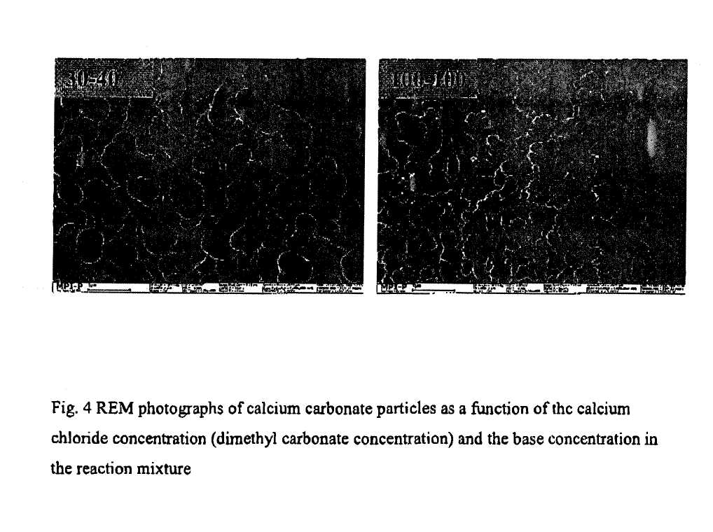

FIG. 4 shows REM photographs of calcium carbonate particles as a function of the calcium chloride concentration and the base concentration in the reaction mixture

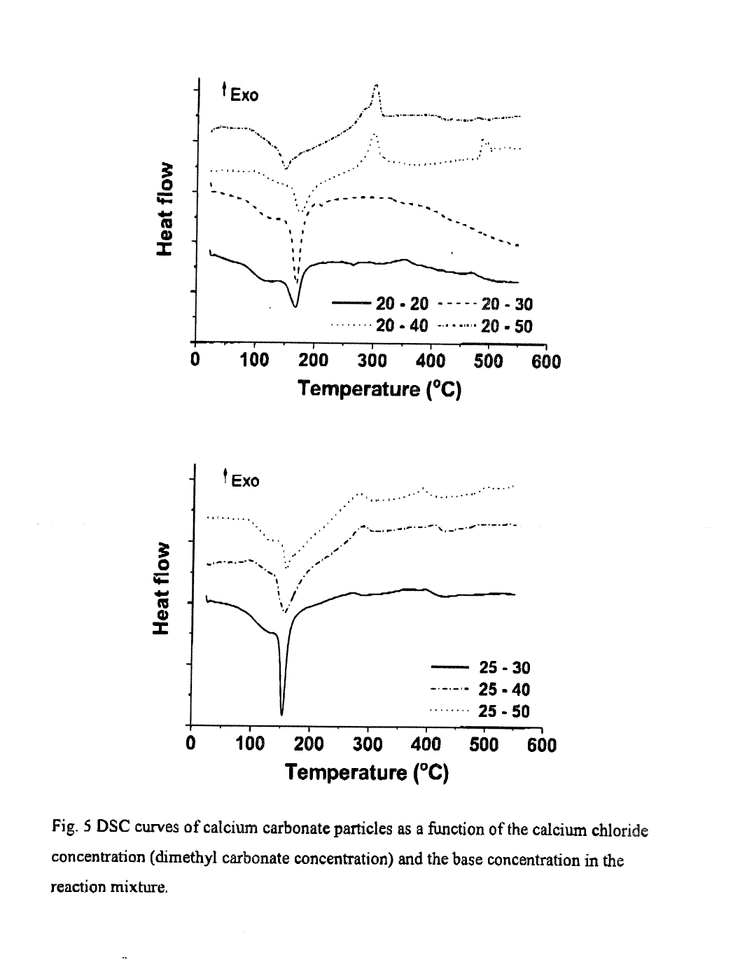

FIG. 5 shows DSC curves of calcium carbonate particles as a function of the calcium chloride concentration and the base concentration in the reaction mixture

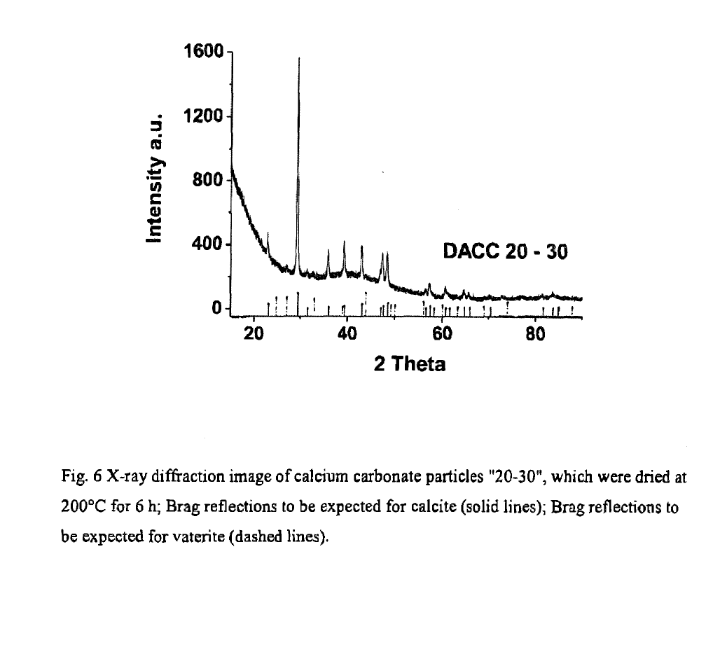

FIG. 6 shows an x-ray diffraction image of dried calcium carbonate particles “20-30”

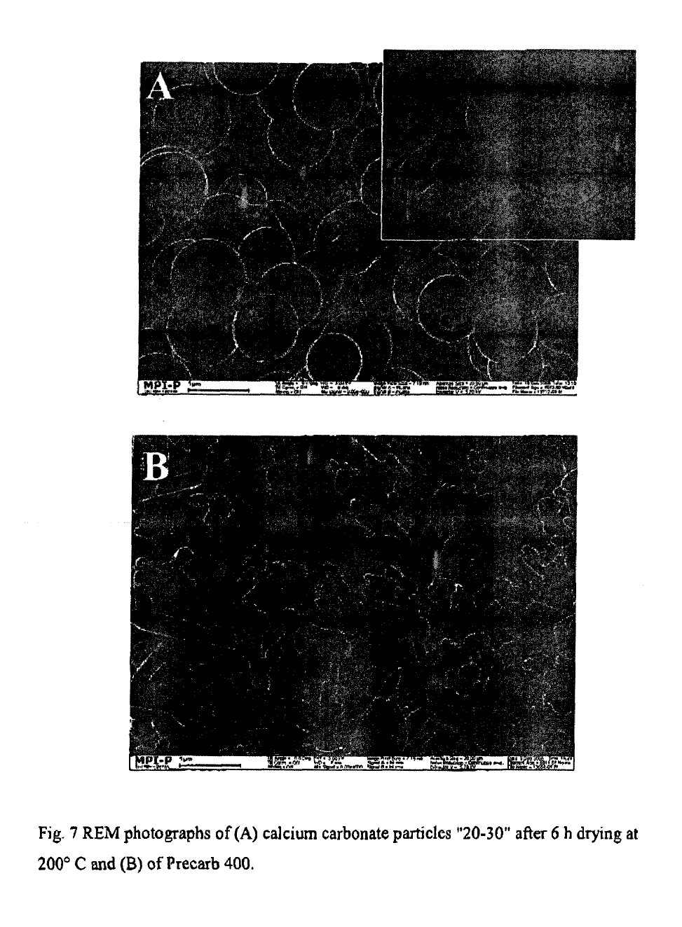

FIG. 7 shows REM photographs of dried calcium carbonate particles “20-30” and of Precarb 400

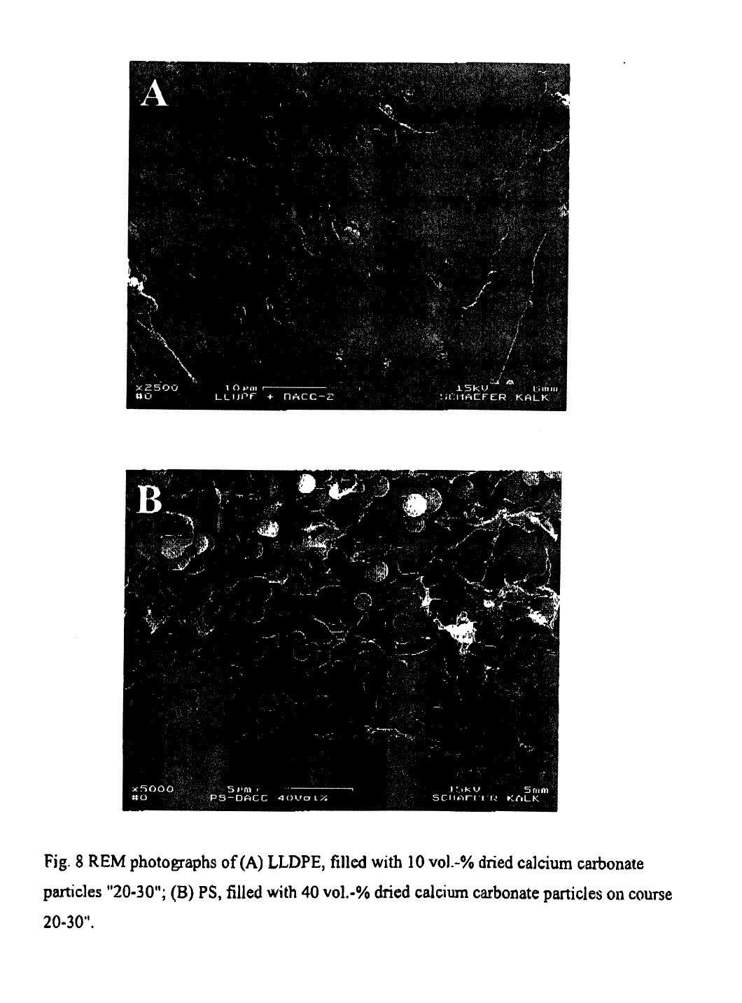

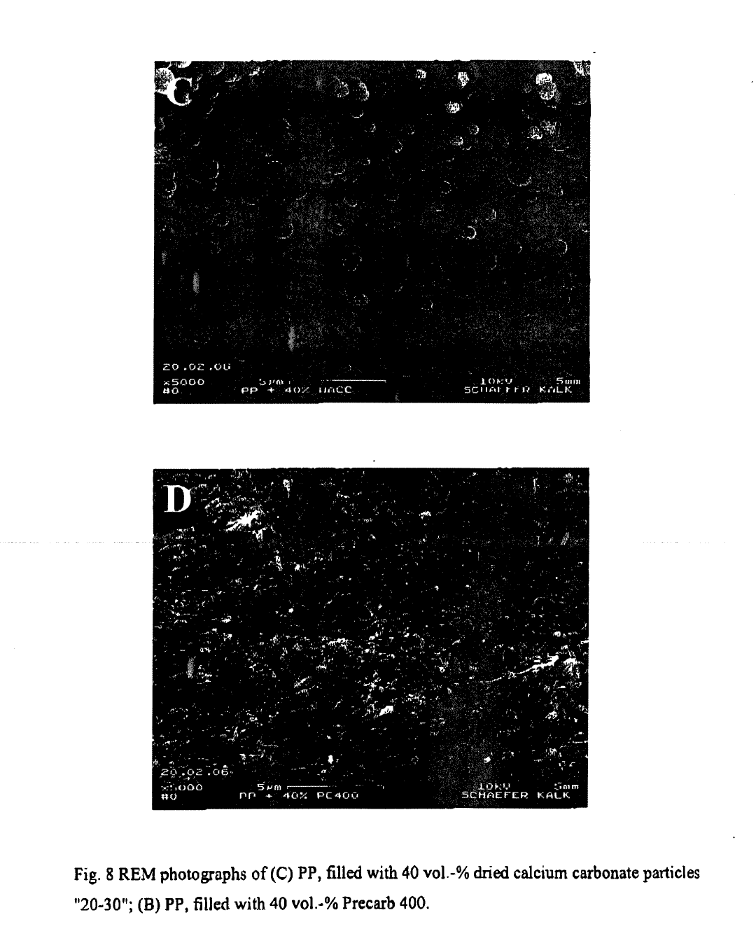

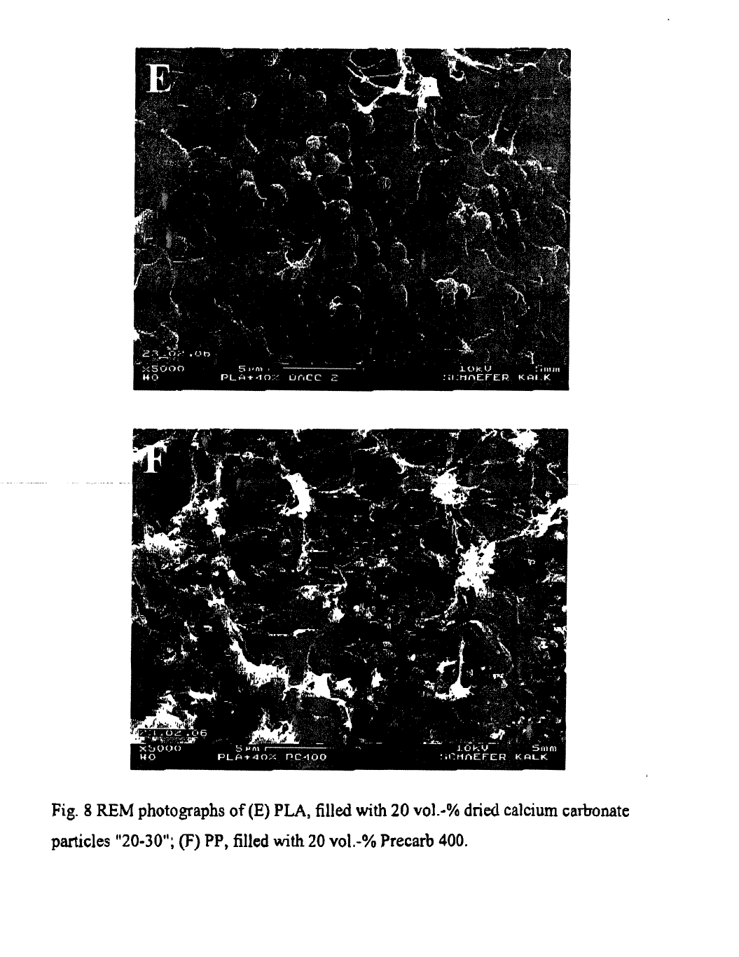

FIG. 8 shows REM photographs of filled LLDPE, PS, PP and PLA

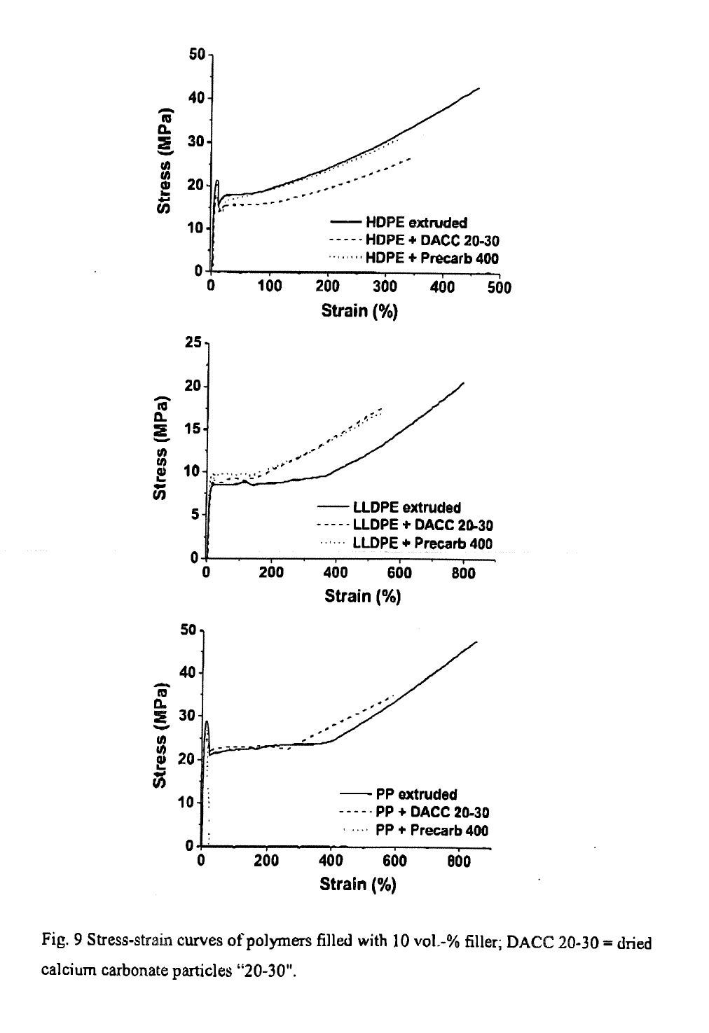

FIG. 9 shows stress-strain curves of, as applicable, filled HDPE, LLDPE and PP

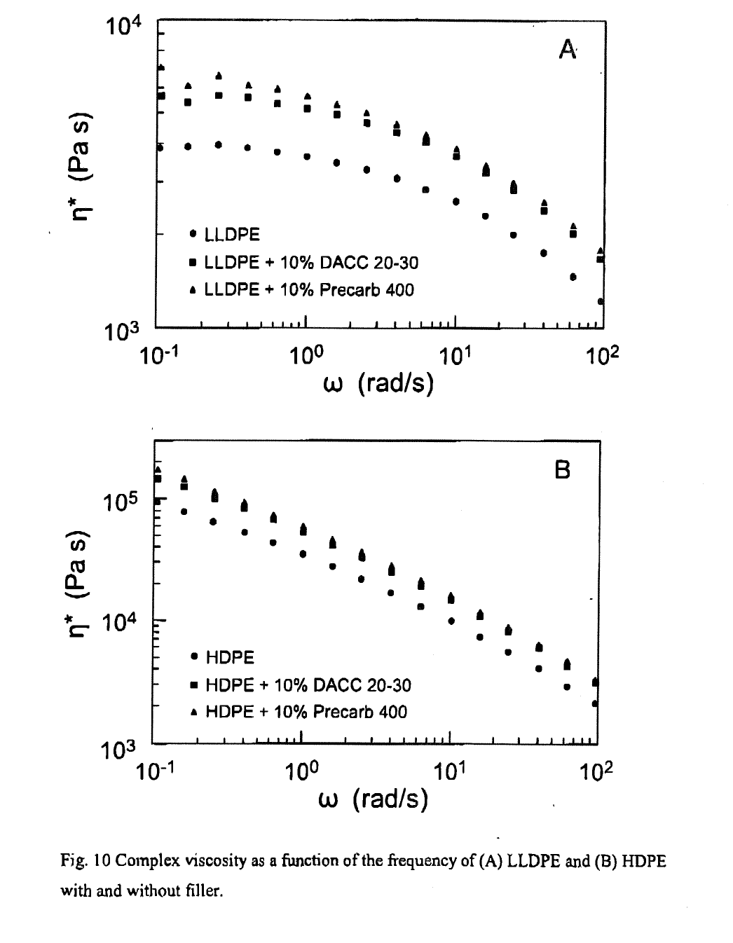

FIG. 10 shows viscosity curves of, as applicable, filled LLDPE and HDPE

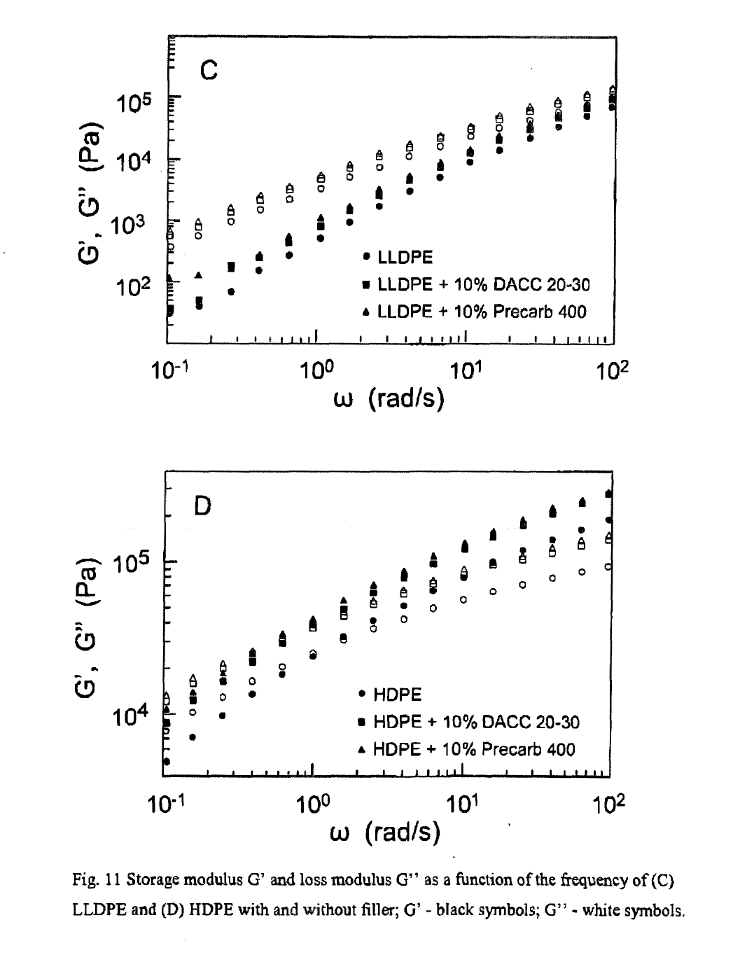

FIG. 11 shows the storage modulus and loss modulus of, as applicable, filled LLDPE and HDPE

### EXAMPLES AND COMPARATIVE EXAMPLES

The invention is illustrated below by several examples and comparative examples, it not being intended hereby to limit the invention to the specific embodiments.

Characterisation

The properties of the calcium carbonate particles and of the polymer compound were determined as follows.

Electron Microscopy

The scanning electron images were produced with a device of type LEO 1530 Gemini with an accelerating voltage of 3 kV (powder) or with a high-voltage electron microscope (Zeiss, DSM 962) at 15 kV (polymer compounds). The extruded samples were broken in liquid nitrogen and sprayed with a gold-palladium layer.

Infrared Spectroscopy

The IR spectra were recorded with a Nicolet 730 FTIR spectrometer, the samples being mixed with KBr.

X-Ray Scattering

The crystalline form of the calcium carbonate particles was ascertained by x-ray scattering (Cu Kα radiation).

DSC

The DSC measurements were carried out under nitrogen on a Mettler-Toledo DSC 30S.

The calibration took place with indium. The measurements were carried out under dry, oxygen-free nitrogen (flow rate: 40 ml/min). The sample weight was selected between 15 mg and 20 mg. The samples were first heated from 25° C. to 230° C., then cooled to 25° C. and heated a second time from 25° C. to 230° C. at a heating rate of 10° C./min.

Thermal Gravimetric Analysis (TGA)

The thermal gravimetric analysis was carried out with a Mettler-Toledo ThermoSTAR TGA under nitrogen in the range from 25° C. to 800° C. at a heating rate of 10° C./min.

Specific Surface Area (BET)

The specific surface area of the particles was carried out by the BET method (Micromeritics Gemini 2360 Analyser) by nitrogen adsorption. The samples were degassed for the adsorption investigations at 130° C. for at least 3 h (FlowPrep 060 Degasser).

Oil Absorption

The oil absorption was measured with diisononylphthalate (DINP) according to the rub-out method similar to EN ISO 787-5. In this test, DINP is mixed with the sample and rubbed with a spatula on a smooth surface, until a hard, cement-like paste is formed which does not fracture or split up. The oil absorption in g/100 g sample was calculated by

$$Oil absorption = \frac{g absorbed DINP}{sample weight , g .} \cdot 100$$

Melt Viscosity

The melt viscosity of the pure polymers and the compounds was ascertained with the rheometer ARES from TA Instruments. Following a strain-flow test, the complex viscosity of the materials was measured in the linear range using parallel plates with a diameter of 13 mm over the frequency range from 0.01 s⁻¹ to 100 s⁻¹.

Mechanical Properties

The mechanical properties were determined by tension tests, which were carried out on an Instron 4200, equipped with a 0.1 kN or 1 kN force transducer. The traversing rate amounted to 10 mm/min. For the measurements, test pieces (2 mm×15 mm×0.16 mm±0.02 mm) were cut out from a film, which was obtained by melting the extruded rods in a hydraulic press at a temperature of 180° C. and under a pressure of 40 kN. At least 4 samples were tested at room temperature for each material.

Synthesis of Calcium Carbonate Particles

Calcium chloride dihydrate and dimethyl carbonate were dissolved in MilliQ water at 20° C. A solution of sodium hydroxide in MilliQ water was prepared in a separate vessel at 20° C. The two solutions were rapidly mixed and the formed deposit was separated from the mother liquor by centrifugation, washed with acetone and dried under vacuum at room temperature. The concentrations of calcium chloride, dimethyl carbonate and sodium hydroxide in the reaction mixture used in the respective examples and the obtained yields are summarised in table 1. The code is also given that is used in the illustrations for the assignment of the examples.

TABLE 1

| | Calcium | Dimethyl | Sodium | |
|---|---|---|---|---|
| Example | chloride | carbonate | hydroxide | Yield |
| “Code” | [mM] | [mM] | [mM] | [% of theory] |
| B1 “20-20” | 20 | 20 | 20 | 19 |
| B2 “20-30” | 20 | 20 | 30 | 29 |
| B3 “20-40” | 20 | 20 | 40 | 35 |
| B4 “20-50” | 20 | 20 | 50 | 40 |
| B5 “25-30” | 25 | 25 | 30 | 25 |
| B6 “25-40” | 25 | 25 | 40 | 35 |
| B7 “25-50” | 25 | 25 | 50 | 44 |
| B8 “30-20” | 30 | 30 | 20 | 10 |
| B9 “30-30” | 30 | 30 | 30 | 17 |
| B10 “30-40” | 30 | 30 | 40 | 31 |
| B11 “30-50” | 30 | 30 | 50 | 40 |
| B12 “40-20” | 40 | 40 | 20 | 7 |
| B13 “40-30” | 40 | 40 | 30 | 12 |
| B14 “50-20” | 50 | 50 | 20 | 4 |
| B15 “60-20” | 60 | 60 | 20 | 3 |
| B16 “80-20” | 80 | 80 | 20 | |
| B17 “100-100” | 100 | 100 | 100 | 16 |

The method of the present invention permits the production of very regular calcium carbonate spheres with a narrow particle size distribution.

The morphology of the obtained calcium carbonate particles is shown by way of example in FIG. 1 for several examples. The mean diameter of the particles diminished from 790 nm for B1 “20-20” to 430 nm for B15 “60-20”. The particle size distribution was wider when the calcium chloride concentration in the reaction mixture was increased. The particles retained their spherical shape up to a calcium chloride concentration of 60 mM. A further increase in the calcium chloride concentration, however, led to a material with a shape difficult to determine and, furthermore, smaller quantities of large spherical particles with a diameter of up to 3-4 μm were observed.

FTIR investigations on the samples show in all cases the main features of amorphous calcium carbonate (FIG. 2A). A broad band at 863 cm⁻¹, an absorption at 1075 cm⁻¹, a broad band at 1440 cm⁻¹ as well as a broad absorption at approx. 3350 cm⁻¹ and at 1640 cm⁻¹ due to the water molecules are observed. For materials which were obtained with higher react and concentrations, weakly formed absorption bands were observed for calcite (712 cm⁻¹). Interestingly, one week after the synthesis the same samples displayed an FTIR absorption spectrum typical of crystalline material with very characteristic absorption bands, which indicated the presence of vaterite (1088, 745 cm⁻¹) and calcite (875 and 712 cm⁻¹) (FIG. 2B).

X-ray diffraction investigations confirmed that a spectrum usual for calcite and vaterite is obtained for the material produced with a calcium chloride concentration of 60 mM. The spectrum also shows, however, that the crystalline polymorphs are not the dominant component, but that a large part of the material continues to be amorphous. This explains why the bands observed in the FTIR spectrum are neither typically “amorphous” nor “crystalline”, which points to the presence of weakly formed crystalline material.

The induction time for the precipitation, characterised by the appearance of cloudiness, increases with increasing concentration of calcium chloride and dimethyl carbonate. A larger quantity of dialkyl carbonate made it possible for the quantity of carbon dioxide required for the nucleation to be reached more quickly, though this was also caused by a high base consumption at the start of the method, which leads to an abrupt reduction in the pH value. Thereafter, the particle growth is inhibited as a consequence of the successive decline in the carbon dioxide concentration.

With higher concentrations of components, the yield diminishes and the particle diameter becomes smaller. The reduction in the base quantity used in the method slows down the hydrolysis of the dimethyl carbonate and influences the supersaturation level. The concentration of the base must not however be too low, because otherwise the supersaturation level changes quickly in the course of the precipitation and as a result, initially formed amorphous calcium carbonate begins to transform into vaterite and calcite. Thus, in samples which are prepared with too little base, small quantities of spherical particles with a diameter of 3-4 μm are found. Furthermore, the amorphous calcium carbonate in the samples is unstable and transforms into calcite within a week at room temperature.

In order to increase the product yield, it is necessary to use higher base concentrations, since the higher pH value speeds up the hydrolysis of the alkali carbonate and this leads to the formation of a sufficient quantity of carbon dioxide in the system (see table 1). The REM photographs show that the particle shape is strongly influenced by the concentration of the components and that materials that have been produced from highly concentrated solutions (B10 “30-40” or R17 “100-100”) have smaller particle sizes and agglomerate more markedly (FIG. 4). FTIR and x-ray diffraction measurements confirm the amorphous morphology of the materials that have been produced from reaction mixtures in which the initial base concentration is greater than 20 mM.

The concentration of the components determines not only the particle size, but also the thermal properties of the material. Depending on the initial concentration, the calcium carbonate particle exhibit one or two distinct thermal transitions in the DSC curves (FIG. 5). The first broad exothermic transition is attributed to the liberation of adsorbed water and structural water. This transition usually comprises two more or less distinguishable signals. A broad signal with a maximum at 100° C.-120° C. is formed more markedly in the case of calcium carbonate which is precipitated at a lower pH. The second narrow signal occurs in the range from 150° C.-170° C. The position and shape of this signal depends in turn on the pH at which the calcium carbonate particles are precipitated. With a higher pH, the signal can be observed at a somewhat higher temperature and becomes broader.

The narrow exothermic transition of the DSC curves at approx. 290° C. is attributed to the complete liberation of water, which is associated with the transformation of the amorphous calcium carbonate into calcite. In the case of materials which are precipitated with higher calcium chloride and dimethyl carbonate concentrations, but with lower base concentrations, this transition is not however always observed. Here, on the contrary, a uniform rise in the base line is observed instead of a signal (FIG. 5 B5 “25-30”). Furthermore, a reduction in the enthalpy of the endothermic processes is also recorded.

The liberation of water observed by the DSC corresponds to the weight loss observed in the TGA. For samples which are synthesised with more than 20 mM base, the measured quantity of water is in the range from 8 wt.-% to 10 wt.-% of the total weight of the materials. Calcium carbonates which are obtained with less base contain much less water and the relative proportion diminishes to 2 wt.-% when the calcium chloride concentration is increased. These materials are however at least partially crystalline.

The amorphous calcium carbonate B2 “20-30” is particularly suitable for the purposes of the present invention. It is constituted by very regular, non-agglomerated particles with a mean particle diameter in the range from 0.9 μm to 1.2 μm, depending on the reaction vessel used. The material is not contaminated with crystalline calcium carbonate forms and has a more than 3 month long-term storage stability, although it is known that amorphous calcium carbonate in itself is not stable and over time transforms spontaneously into crystalline forms in the presence of moisture.

Drying of Amorphous Calcium Carbonate

Example B2 was dried in the drying oven at a preset temperature for a preset time. A partial crystallisation to form calcite took place here, which did not however change anything regarding the spherical morphology. The specific surface area (BET) grew from 2 m²/g to 12 m²/g. The residual water content of the dried ACC was determined by means of thermal gravimetric analysis (TGA). The results are summarised in table 2.

TABLE 2

| | Temperature | Time | Residual water content |
|---|---|---|---|
| Test | [° C.] | [h] | [wt.-%] |
| V1 | RT | 0 | 9 |
| V2 | 120 | 1 | 6.7 |
| V3 | 120 | 3 | 5.7 |
| V4 | 120 | 6 | 4.3 |
| V5 | 120 | 24 | 2.5 |
| V6 | 160 | 1 | 2.2 |
| V7 | 160 | 3 | 1.5 |
| V8 | 160 | 6 | 1.3 |
| V9 | 160 | 24 | 0.9 |
| V10 | 180 | 1 | 1.0 |
| V11 | 180 | 3 | 0.5 |
| V12 | 180 | 6 | 0.3 |
| V13 | 180 | 24 | 0.3 |
| V14 | 200 | 1 | 0 |
| V15 | 200 | 3 | 0 |
| V16 | 200 | 6 | 0 |
| V17 | 200 | 24 | 0 |

Drying the material at 80° C. for 72 hours in air induced the crystallisation of the material and the x-ray diffraction image showed weak reflections of calcite. The water content after this drying was approx. 2 wt.-% according to TGA.

Otherwise the following applies: The higher the temperature and the longer the drying time, the greater the liberated quantity of water. The water loss is accompanied by a transformation of the material into calcite (FIG. 6). The x-ray diffraction images show, however, that this crystallisation process only occurs slowly even at higher temperatures. Even after 6 hours at 200° C., the material is at least partially still amorphous. The morphology of the particles does not change during the drying. Only the surface of the spheres becomes somewhat rougher (see FIG. 7A). Some of the spherical particles display a restructured surface and small particles with diameters of approx. 30 nm -40 nm inside the spheres (insertion in FIG. 7A) which can be attributed to calcite. The crystal sizes, which were ascertained from the Debye-Scherer x-ray diffraction images, indicate crystals with a diameter in the range from 25 nm-35 nm.

Polymer Compounds

Dried amorphous calcium carbonate V16 was incorporated into linear polyethylene of low density (LLDPE), polyethylene of high density (HDPE), polypropylene (PP), polystyrene (PS) and polylactic acid (PLA). As a reference, use was made of precipitated calcium carbonate (Precarb 400 from Schaefer Kalk GmbH & Co. KG) with needle-shaped (aragonite) and somatoid (calcite) particles, which is used commercially as a functional filler for, for example, hard PVC compounds. Both fillers were used without surface modification.

The properties of dried amorphous calcium carbonate V16 and of a commercial material (Precarb 400) are shown in table 3 and FIG. 7. The two materials differ markedly in the particle shape. Amorphous calcium carbonate V16 has a regular spherical shape, whereas Precarb 400 partially comprises needles with a high shape factor. The specific surface area and the DFNP absorption are somewhat less in the case of calcium carbonate V16, but the accessibility of the surface is comparable.

TABLE 3

| Parameter | V16 | Precarb 400 |
|---|---|---|
| Polymorph | calcite/vaterite/ | aragonite/calcite |
| | amorphous | |
| Particle shape and mean | Spheres | Needles and somatoids |
| particle size | 1.15 μm | 1.16 μm × 0.20 μm |
| Specific surface area (BET) | 12.2 m²/g | 8.4 m²/g |
| DINP absorption | 51 g/100 g | 68 g/100 g |

The dried V16 powder and the Precarb 400 powder were next mixed mechanically with polymer powder or granulate. 5 g of this mixture was then extruded with a double-screw extruder. The extrusion temperature was 230° C. for LLDPE, HDPE and PP and 200° C. for PLA. Extrusion was carried out at a screw speed of 100 rpm under a nitrogen atmosphere. The quantities of polymer and filler used in each case are set out in table 4.

TABLE 4

| | | | Proportion of | Proportion of |
|---|---|---|---|---|
| | | | filler in the | filler in the |
| | | | mixture used | compound |
| Compound | Polymer | Filler | [wt.-%] ([vol.-%]) | [wt.-%] |
| C1 | LLDPE | Precarb 400 | 23.1 (10) | 20.8 |
| C2 | LLDPE | V16 | 23.1 (10) | 21.1 |
| C3 | HDPE | Precarb 400 | 23.1 (10) | 23.7 |
| C4 | HDPE | V16 | 23.1 (10) | 25.0 |
| C5 | PP | Precarb 400 | 23.1 (10) | 14.5 |
| C6 | PP | V16 | 23.1 (10) | 19.3 |
| C7 | PP | Precarb 400 | 64.3 (40) | 56.4 |
| C8 | PP | V16 | 64.3 (40) | 55.2 |
| C9 | PS | Precarb 400 | 23.8 (10) | 18.9 |
| C10 | PS | V16 | 23.8 (10) | 19.9 |
| C11 | PLA | Precarb 400 | 19.5 (10) | 4.3 |
| C12 | PLA | V16 | 19.5 (10) | 22.6 |
| C13 | PLA | Precarb 400 | 40.0 (20) | 41.3 |
| C14 | PLA | V16 | 40.0 (20) | 32.9 |

Already with the compounding, it could be seen that the compounds with VI 6 are easier to produce. Especially in the case of the statistically unfavourable pre-mixing of granulate and powder with polylactic acid which is difficult to process, the incorporation of 20 wt.-% of dried amorphous calcium carbonate was able to be achieved much more precisely than with the conventional Precarb 400.

The proportion of inorganic filler in the compound was ascertained by means of TGA investigations and is also shown in table 4. The ascertained values are in good agreement in most cases with the quantities used.

The quality of the dispersion of the filler material can be judged on the basis of the REM photographs (FIG. 8). A reasonable distribution of the calcium carbonate particles was achieved in all cases. However, the use of V16 led to better results. Large aggregates are not observed, which indicates that the shearing forces during the extrusion were sufficiently great. In contrast, small aggregates were occasionally found for Precarb 400, which were not broken up during the processing. The elongated particles of this material tend towards a preferential direction in the extrusion direction, although some particles are also observed with an orientation normal to the extrusion direction. This indicates that the shearing forces did not suffice to orientate all the particles perfectly.

Furthermore, the materials extruded with Precarb 400 have a rougher surface than the materials extruded with V16.

Investigations into the fracture surfaces show faults between the calcium carbonate particles and the polymer matrix, which can be traced back to a non-optimised compatibility of the inorganic and the organic components. Some of the particles become detached by breaking of the polymer. A somewhat better adhesion of the polymer to the inorganic filler can be detected in the REM photographs of the polylactic acid-based compounds. Lactic acids formed during the extrusion possibly act as a binder between the polymer and the calcium carbonate surface.

Although the drying of the amorphous calcium carbonate led to smaller calcite crystals in the spheres, the V16 overcame the shearing forces during the extrusion and did not break up.

In the DSC measurements, the LLPDE, HDPE and PP compounds showed only one melting endotherm and during cooling only one crystallisation signal (table 5). The thermal properties of the semi-crystalline polyolefins are hardly affected at all by the fillers, and this points to the fact that the interactions between the polymer and the filler are negligibly small. With PLA as a matrix, however, both fillers lead to a reduction in the glass transition temperature and the melting temperature, which is proportional to the filler content.

TABLE 5

| Material | ΔHₘ (J/g) | Tₘ (° C.) | Tc (° C.) | Tg (° C.) |
|---|---|---|---|---|
| LLDPE | 90.0 | 127.2 | 104.0 | — |
| C1 | 104.8 | 129.3 | 105.8 | — |
| C2 | 112.9 | 129.6 | 104.8 | — |
| HDPE | 167.0 | 136.8 | 109.8 | — |
| C3 | 160.0 | 140.0 | 105.2 | — |
| C4 | 164.7 | 139.0 | 106.7 | — |
| PP | 66.7 | 169.0 | 111.3 | — |
| C5 | 71.1 | 165.4 | 116.6 | — |
| C6 | 71.3 | 167.4 | 116.1 | — |
| C7 | 69.5 | 163.7 | 120.9 | — |
| C8 | 70.5 | 163.1 | 126.4 | — |
| PLA | 31.5 | 159.8 | — | 68.2 |
| C11 | 26.3 | 159.4 | — | 61.9 |
| C12 | 23.9 | 158.2 | — | 60.8 |
| C13 | 32.5 | 162.0 | — | 59.3 |
| C14 | 22.5 | 161.2 | — | 59.9 |

The influence of the fillers on the strain behaviour is summarised in table 6. Both fillers basically lead to an increase in the modulus of elasticity and a decrease in the tensile strength and elongation at tear. The elongation at tear decreases for all compounds compared to the unfilled material, although the decrease for polymers filled with spherical calcium carbonate particles is smaller. The elongated Precarb 400 particles lead to failure with very little elongation at tear. This can presumably be traced back to the shape of the particles or a non-homogeneous distribution of the particles in the polymer matrix.

TABLE 6

| | Tensile strength | Tensile modulus | Elongation at tear |
|---|---|---|---|
| Material | [MPa] | [MPa] | [%] |
| LLDPE | 22 ± 0.8 | 161 ± 4 | 686 ± 24 |
| C1 | 13 ± 3.7 | 168 ± 40 | 390 ± 182 |
| C2 | 20 ± 2.5 | 169 ± 26 | 689 ± 60 |
| HDPE | 38 ± 4 | 631 ± 27 | 531 ± 51 |
| C3 | 27 ± 3.7 | 844 ± 157 | 511 ± 47 |
| C4 | 23 ± 6.4 | 823 ± 46 | 415 ± 186 |
| PP | 47 ± 2.6 | 798 ± 91 | 933 ± 29 |
| C5 | 28 ± 2.2 | 1029 ± 95 | 58 ± 14 |
| C6 | 32 ± 5 | 990 ± 40 | 651 ± 129 |

The tensile yield strength of the filled polymers is lower in the stress-strain curves (FIG. 9), the lowest values being observed for the polymers filled with V16. The decrease in the tensile yield strength should be proportional to the factor (1−φ), wherein (p is the volume fraction of the filler when a detachment of the particles from the polymer matrix takes place under stress. The decrease in the tensile yield strength was approx. 10% for the materials filled with V16, whereas only approx. 5% was observed for materials filled with Precarb 400. This indicates a weak adhesion of the polymers to the particles.

The presence of the solid fillers in thermoplastic polymers influences their processability. The complex viscosity (η*) of the unfilled LLDPE and HDPE and the LLDPE and HDPE filled with 10 vol.-% calcium carbonate at frequencies in the range from 0.01 s⁻¹ to 100 s⁻¹ at 190° C. and 200° C. are shown in FIGS. 10A and 10B. The viscosity values of each system diminish with increasing oscillation rate on account of the shear dilution effect. The filler particles increase the viscosity of the compounds compared to the unfilled polymers. The difference between LLDPE filled with V16 and LLDPE filled with Precarb 400 is approx. 20% at low frequencies, whereas this difference amounts to only approx. 6% for HDPE. At higher frequencies, the difference between the viscosities of unfilled and filled polymers diminishes. The higher viscosity of the materials filled with Precarb 400 can be attributed to the partial orientation of the particles during the extrusion.

The complex shear modulus as a function of the frequency is reproduced in FIGS. 11C and 11D for unfilled and filled LLDPE and HDPE. The filled samples display flow behaviour which resembles that of the unfilled polymers. A weak increase in the storage modulus (G′) and the loss modulus (G″) with increasing frequency can be detected for all the samples. The values of G′ and G″ were higher for the filled polymers. The LLDPE containing Precarb 400 displayed a significant increase in the storage modulus at low frequencies, which could be due to the formation of agglomerates.

1. Spherical calcium carbonate particles with a mean particle diameter in the range from 0.05 μm to 1.75 μm and a water content of at most 5.0 wt.-%, related to their total weight, wherein
the proportion of crystalline calcium carbonate is less than 90 wt.-% and
the calcium carbonate particles are obtained by a method wherein
i) calcium chloride is reacted in an aqueous solution with dialkyl carbonate in the presence of an alkali metal hydroxide, wherein the components are used in the following concentrations:
a) CaCl₂: >10 mmol/l to 50 mmol/l;
b) dialkyl carbonate: >10 mmol/l to 45 mmol/l;
c) alkali metal hydroxide: 20 mmol/l to 100 mmol/l.
ii) the obtained product is separated and dried.

2. The calcium carbonate particles according to claim 1, wherein the calcium carbonate particles have a water content of at most 1.0 wt.-%, related to their total weight.

3. The calcium carbonate particles according to claim 1, wherein at least 90.0 wt.-% of all the calcium carbonate particles have a particle size in the range from mean particle diameter −30% to mean particle diameter +30%.

4. The calcium carbonate particles according to claim 1, wherein the quotient of the minimum particle diameter and the maximum particle diameter is greater than 0.90 for at least 90% of all the particles.

5. The calcium carbonate particles according to claim 1, wherein the proportion of crystalline calcium carbonate, related to their total weight, is less than 50 wt.-%.

6. The calcium carbonate particles according to claim 1, wherein the particles are at least partially crystalline.

7. The calcium carbonate particles according to claim 5, wherein the calcium carbonate crystals have a particle size less than 50 nm.

8. The calcium carbonate particles according to claim 1, charactised in that wherein the calcium carbonate particles have a specific surface area in the range from 2 m²/g to 20 m²/g.

9. The calcium carbonate particles according to claim 1, wherein the calcium carbonate particles can be obtained by a method, wherein the molar ratio of calcium chloride to alkali metal hydroxide in the reaction mixture is selected greater than 0.5:1.

10. The calcium carbonate particles according to claim 1, wherein the calcium carbonate particles can be obtained by a method, wherein the molar ratio of calcium chloride to dialkyl carbonate in the reaction mixture is selected in the range from 0.9:1.5 to 1.1:1.

11. The calcium carbonate particles according to claim 1, wherein the calcium carbonate particles can be obtained by a method, wherein the reaction is carried out at a temperature in the range from 15° C. to 30° C.

12. The calcium carbonate particles according to claim 1, wherein the calcium carbonate particles can be obtained by a method, wherein dimethyl carbonate is used as dialkyl carbonate and sodium hydroxide as alkali metal hydroxide.

13. The calcium carbonate particles according to claim 1, wherein the calcium carbonate particles can be obtained by a method, wherein the reaction product is separated and dried at a temperature in the range from 150° C. to 220° C.

14. (canceled)

15. A polymer compound, containing amorphous calcium carbonate according to claim 1.

16. The polymer compound according to claim 15, containing, related respectively to its total volume, 99.9 vol.-% to 50.0 vol.-% of at least one polymer and 0.1 vol.-% to 50.0 vol.-% of spherical calcium carbonate particles.

17. The polymer compound according to claim 15, containing at least one thermoplastically processable polymer.

18. The polymer compound according to claim 15, containing polyethylene, polypropylene, polystyrene and/or polylactic acid.
